(19) United States
(12) Patent Application Publication
(10) Pub. No.: US 2010/0055233 A1
(43) Pub. Date: Mar. 4, 2010

(54) Optimized Flavored Polymeric Compositions

(75) Inventors: Kari L. Macinnis, Copley, OH (US); Tomy Widya, Cuyahoga Falls, OH (US)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(73) Assignee: A. SCHULMAN, INC, Akron, OH (US)

(21) Appl. No.: 12/583,979

(22) Filed: Aug. 28, 2009

Related U.S. Application Data
(60) Provisional application No. 61/190,511, filed on Aug. 29, 2008.

(30) Foreign Application Priority Data
Oct. 9, 2008 (EP) 08253299.5

(51) Int. Cl. A23L 1/226

(52) U.S. Cl. 426/6

(57) ABSTRACT

The present invention relates to optimization of flavored polymeric compositions and methods of producing optimized flavored polymeric compositions. More specifically, the invention relates to flavored polymeric compositions comprising “flavor enhancing agents” alone or in combination with other flavorants as well as polymeric articles made from the same, wherein articles made from such polymeric compositions are not intended to be consumed, significantly destructed, masticated or fully or partially dissolved to release flavor.

### FIELD OF THE INVENTION

The present invention relates to optimization of flavored polymeric compositions and methods of producing optimized flavored polymeric compositions. More specifically, the invention relates to flavored polymeric compositions comprising “flavor enhancing agents” alone or in combination with flavorants, wherein articles made from such polymeric compositions are not intended to be consumed, significantly destructed, masticated or fully or partially dissolved to release flavor.

### BACKGROUND OF THE INVENTION

It is well known that flavor enhancing agents and/or flavorants are used in a wide variety of applications, such as oral rinses, toothpastes, chewing gums, dissolvable strips, tablets, beverages, confections and a variety of foodstuffs. Alone or in a variety of combinations, these flavor enhancing agents and/or flavorants render to the user a specific, targeted flavor sensation.

By flavorants, we refer to natural or artificial flavored substances, extracts, or essential oils. It should also be understood that in discussing flavorant or flavorants, we are referring to the use of a single flavorant or any possible combination of flavorants to achieve the desired flavor.

In reference to “flavor enhancing agents”, we refer to natural or synthetic substances which provide sweet, sour, bitter, salty, acidic, umami, fatty acid or cooling taste sensation or any combinations thereof.

In these standard applications, the flavorants, combined with other necessary ingredients are typically distributed into the appropriate carrier for the application. Oral rinses and toothpastes would include flavorants and/or flavor enhancing agents in a liquid or paste medium. In these applications, the user experiences a rapid and appropriately intense flavor sensation due to intimate contact of the flavored ingredients in the oral cavity.

Dissolvable films and tablets also provide for intimate contact of the flavored ingredients into the oral cavity upon dissolution of the host matrix. For example, WO 02/45571 teaches a fast dissolving tablet comprising a low melting point compound carrier that melts or softens at or below 37 C, a water soluble excipient, and a pharmaceutically active ingredient. Optionally, the tablet can contain flavors and flavor enhancers to deliver flavor while the tablet is dissolved. Similarly, U.S. Pat. No. 6,419,903 teaches an orally consumable film composition which is rapidly dissolvable in the oral cavity, the composition being comprised of a water soluble cellulosic carrier, a water dispersible pregelatized starch, and a flavoring agent, including sweeteners.

In the aforementioned examples, the flavorants and/or flavor enhancing agents are distributed into the appropriate carrier, such as water soluble or dissolvable carriers. The dissolution of the carrier provides effective release of the flavor ingredients into the oral cavity to achieve the targeted flavor sensation.

It is widely known that chewing and/or bubble gums also include flavorants and/or flavor enhancing agents. The gum base is a masticatory material, often water insoluble, used to carry flavors and flavor enhancing agents in gums. Gums also consist of a water soluble bulk portion. By reference, U.S. Pat. No. 5,100,678 explains that “the water-soluble portion dissipates with a portion of the flavoring agent over a period of time during chewing. The gum base portion is retained in the mouth throughout the chew.” The gum base is often comprised of natural or synthetic elastomeric materials such as chicle, natural rubber, polyvinyl acetate, styrene-butadiene copolymers, polyisobutylene, and the like. By reference, the US FDA lists approved masticatory substances for use in chewing gum under 21 CFR 172.615.

In the examples above, a commonality can be found in that these carriers provide flavor upon the consumption, mastication, dissolution, partial or full destruction of the article. Yet, there exist application needs for flavored polymeric articles which are not intended to be subjected to such end routes.

Articles produced from polymeric materials exist in a wide variety of applications. Many applications involve the polymeric article to be used or in contact with the oral cavity, but which are not intended to be masticated or dissolved. Examples of such applications include tongue depressors, mouth swabs, dental appliances, dental molds, retainers, mouthguards, protective dental films, toothbrushes, toothbristles, dental exam gloves, pacifiers, teething toys and rings, straws, bottles, bottle caps and spouts, drink lids, utensils, adult novelty and the like. In the best case, polymeric articles used in such applications can be considered to have a neutral flavor, but more often, they are described as having a “plastic” taste which causes an unpleasant experience to the user.

As mentioned, in these other applications it is desirable to have flavored polymeric articles which can provide flavor without requiring consumption, dissolution, mastication, or destruction of the article. For these applications, flavoring an article has been achieved by either direct incorporation of the flavorant into a polymeric carrier or by applying a flavored coating to the final formed polymeric article. In the case of coated polymeric articles, the user can experience the targeted flavor sensation because the flavorant exists on the surface of the article, often in a wax carrier, to provide more intimate and immediate release to the oral cavity.

EP 0 919 208 teaches a highly flavored dental article for cleaning the interproximal surfaces of the teeth such as dental floss comprising one filament having a flavored water-insoluble coating. The water-insoluble coating composition is comprised of a water-insoluble wax, flavor, and flavor enhancer. WO 02/4448 discloses a bicomponent monofilament tape wherein the tape is made from the fusion of the sheaths of at least about 60 bicomponent core-sheath fibers and capable of carrying more flavor than comparable flosses. The flavored composition is wax-based and applied as a coating and is not integrally mixed into a polymeric base.

Drawbacks exist to this approach of applying flavored coatings on polymeric articles. One problem is that the while the coating can provide the appropriate intensity and flavor, this effect is short lived because the flavorant and even the coating itself can be depleted from the surface and cannot be replenished. In addition, this approach causes added cost due to the secondary coating process, as well as requiring capital investment in coating machinery.

There are also problems in the case of direct incorporation of the flavorant into a polymeric carrier. A significant problem is that the intensity of flavor is weak because of the lack of sufficient flavor on the surface. Even though the flavorant may be able to migrate to the surface, especially when used in an appropriate polymeric matrix that facilitates the flavorant migration, the final effect is still greatly diminished resulting in an inferior flavor sensation. This result even extends to those articles which can be moderately compressed, e.g. by human chewing or grinding, and which still does not release adequate flavor sensation to the mouth.

In the case of articles which are not intended to be masticated, or even only mildly to moderately compressed, the use of flavored extracts alone through direct incorporation into the polymeric carrier exhibits inferior performance.

Direct incorporation of flavorants into a polymeric carrier for articles not intended to be masticated or dissolved is widely known. U.S. Pat. No. 4,971,078 describes a filter for a smoking article which includes a hollow fiber made of a thermoplastic, where a flavorant is dispersed in the thermoplastic. Such flavorants blended with thermoplastics are commercially available from such companies as International Flavors and Fragrances, Inc. WO/2008/000800 describes an oral hygiene implement made of a thermoplastic elastomer, a plasticizing oil, and a lipophilic flavoring substance. U.S. Pat. No. 6,505,961 to McGovern teaches an intraoral radiographic film packet which has a thermoplastic comfort enhancing perimeter frame permanently integrated therewith during manufacture, the thermoplastic from which the comfort enhancing perimeter frame is molded having flavor/scent chemistry compounded therein prior to molding. The additives to give flavor/scent to the thermoplastic material are blended and melted in an extruder to achieve flavor/scent integral to the thermoplastic frame. US Pat. Application 2007/0235039 by Gottsch describes a mouthguard formed of a resilient material and a flavor agent incorporated into the resilient material prior to formation of the mouthguard.

The aforementioned art relates to dispersing or embedding, i.e. direct incorporation, of flavorants into polymers which are not intended to be dissolved or masticated during use. However, there are problems with this approach. The use of flavorants alone provides predominantly a strong scent, but only affords weak taste in these instances resulting in an inferior flavor response. It is believed that such polymeric articles significantly limit the accessability of the taste of the flavorant to the oral cavity, unlike masticatory or partially or fully dissolvable matricies, thereby causing an inferior perceived flavor. This result even extends to those polymeric articles which can be moderately compressed, e.g. by human biting, and which still does not afford adequate perception of the taste component of a flavor.

Physiologically, the sensory perception of flavor results from a combination of taste and smell. Taste is one of the traditional senses with receptors located in the taste buds found on the tongue. The four basic tastes are sweet, bitter, sour, and salty. Umami and fatty acid tastes have also been suggested as other taste categories.

Flavorants may provide both taste and aromatic components in articles which can be consumed, masticated, or significantly destructed. For flavorants in polymeric carriers which are not expected or intended to be manipulated in this way to release the flavor, the flavorant provides predominantly an aromatic component, but very little taste sensation so that the ultimate flavor perception is significantly diminished. While not wishing to be bound to a particular theory, it is believed that these types of polymers and applications do not permit enough taste sensation due to insufficient access of flavor to the oral cavity and/or the inability of the article to be manipulated (compressed) enough through the action of the user, thereby severely retarding the sensation or release of the flavor.

### SUMMARY OF THE INVENTION

What we therefore believe to comprise our invention may be summarized inter alia in the following words:

A process for producing a flavored (thermoplastic) polymeric composition, comprising optionally selecting one or more heat stable flavorant, selecting one or more heat stable flavor enhancing agent, selecting one or more polymers for a capacity for providing for flavorant and flavor enhancing agent migration in a finished product, as measured by a running water test, as well as thermal stability of the optional flavorant and flavor enhancing agent, blending the selected optional one or more flavorant(s) and one or more flavor enhancing agent(s) and one or more polymers selected from thermoplastics, thermosets, and silicone polymers, and additives selected from antioxidants, antistatics, antifogs, antimicrobials, slips, antiblocks, minerals, fillers, optical brighteners, foaming agents, nucleating agents, impact modifiers, dispersing aids, release agents, waxes, colorants, pigments, UV stabilizers;

such a process, wherein the flavored polymeric composition is in the form of a masterbatch;

such a process, wherein the polymer is selected from polyolefins, thermoplastic polymers, thermoset polymers, and silicone polymers;

such a process, wherein the polyolefin is selected form polyethylene and polypropylene, and copolymers or terpolymers thereof;

such a process, wherein the flavorant is selected from natural and artificial fruit and mint flavors;

such a process, wherein the flavor enhancing agent and flavorant are suitable for human consumption;

such a process, wherein the flavor enhancing agent is selected for its ability to provide sweetness, sourness, bitterness, saltiness, coolness, umami, fatty acid, or acidity;

such a process, wherein the flavor enhancing agent providing for acidity is selected from citric acid, ascorbic acid, malic acid and fumaric acid;

such a process, wherein the flavored thermoplastic polymeric composition is compounded such that flavor and flavor enhancing agent migrate and release or are experienced/perceived without consuming, dissolving, mastication or destruction of an article made from the composition;

such a process, wherein the polymer is selected for its ability to provide flavorant and flavor enhancing agent migration such that 0-80 percent of the flavorant and flavor enhancing agent are retained at one hour in a use environment, 80-40 percent of the flavorant and flavor enhancing agent are retained at ten hours in a use environment and 40-20 percent of the flavorant and flavor enhancing agent are retained at one hundred hours in a use environment;

such a process, wherein perceived flavor is measured in a running water test;

such a process, wherein the flavored thermoplastic polymeric composition is substantially free of a plastic flavor;

as well as a polymeric article molded or extruded from a flavored thermoplastic polymeric composition which is compounded by a process for producing a flavored (thermoplastic) polymeric composition, comprising optionally selecting one or more heat stable flavorant, selecting one or more heat stable flavor enhancing agent, selecting one or more polymers for a capacity for providing for flavorant and flavor enhancing agent migration in a finished product, as measured by a running water test, as well as thermal stability of the optional flavorant and flavor enhancing agent, blending the selected optional one or more flavorant(s) and one or more flavor enhancing agent(s) and one or more polymers selected from thermoplastics, thermosets, and silicone polymers, and additives selected from antioxidants, antistatics, antifogs, antimicrobials, slips, antiblocks, minerals, fillers, optical brighteners, foaming agents, nucleating agents, impact modifiers, dispersing aids, release agents, waxes, colorants, pigments, UV stabilizers;

such a polymeric article, which exhibits an optimized flavor sensation upon placement in a use environment;

such a polymeric article, which exhibits an optimized flavor sensation upon placement in a use environment and without consuming, dissolving, mastication or destruction of such article;

such a polymeric article, which exhibits enhanced flavorant and flavor enhancing agent migration such that 0-80 percent of the flavorant and flavor enhancing agent are retained at one hour in a use environment, 80-40 percent of the flavorant and flavor enhancing agent are retained at ten hours in a use environment and 40-20 percent of the flavorant and flavor enhancing agent are retained at one hundred hours in a use environment;

such a flavored (thermoplastic) polymeric composition which compounded by the process; and

favored polymeric compositions, comprising one or more heat stable flavor enhancing agent which provides the taste component of flavor, optionally one or more heat stable flavorant, one or more polymer(s) characterized by a capacity for providing for flavor enhancing agent and optional flavorant migration in a finished product, as well as being characterized by thermal stability of the flavor enhancing agent and optional flavorant, wherein the one or more polymer(s) are selected from thermoplastics, thermosets, and silicone polymers, and wherein the composition optionally comprises additives selected from antioxidants, antistatics, antifogs, antimicrobials, slips, antiblocks, minerals, fillers, optical brighteners, foaming agents, nucleating agents, impact modifiers, dispersing aids, release agents, waxes, colorants, pigments, UV stabilizers, wherein articles made from such polymeric compositions are not intended to be consumed, significantly destructed, masticated or fully or partially dissolved to release flavor;

such flavored polymeric compositions, which are in the form of a masterbatch, a dry-powder or liquid concentrate;

such flavored polymeric compositions, wherein the polymer is selected from polyolefins, thermoplastic polymers, thermoset polymers, and silicone polymers;

such flavored polymeric compositions, wherein the polyolefin is selected form polyethylene and polypropylene, copolymers or terpolymers thereof;

such flavored polymeric compositions, wherein the flavorant is selected from natural and artificial fruit, mint, and chocolate flavors;

such flavored polymeric compositions, wherein the flavorant is suitable for human consumption;

such flavored polymeric compositions, wherein the flavor enhancing agent provides the taste component of flavor;

such flavored polymeric compositions, wherein the flavor enhancing agent is selected for its ability to provide sweetness, sourness, bitterness, saltiness, coolness, umami, fatty acid, or acidity;

such flavored polymeric compositions, wherein the sweetness flavor enhancing agent is selected from sucrose, fructose, glucose, sorbitol, malitol, xylitol, aspartame, saccharin, sucralose, acesulfame K, mannitol, erythritol, isomalt, lactitol, maltitol, cyclamates, stevia extracts, agave nectar and the like and any combination thereof;

such flavored polymeric compositions, wherein the cooling flavor enhancing agent is selected from menthol derivatives, menthyl lactate, N,2,3,-trimethyl-2-isopropylbutanamide and the like;

such flavored polymeric compositions, wherein the flavor enhancing agent providing for acidity is selected from citric acid, ascorbic acid, malic acid and fumaric acid;

such flavored polymeric compositions, wherein the compositions are compounded such that flavor and flavor enhancing agent migrate and release without consuming, dissolving, mastication or destruction of an article made from the composition;

such flavored polymeric compositions, wherein the polymer is selected for its ability to provide flavorant and flavor enhancing agent migration such that 0-80 percent of the optional flavorant and flavor enhancing agent are retained at one hour in a use environment, 80-40 percent of the flavorant and flavor enhancing agent are retained at ten hours in a use environment and 40-20 percent of the flavorant and flavor enhancing agent are retained at one hundred hours in a use environment;

such flavored polymeric compositions, which are substantially free of a plastic flavor; and

polymeric articles molded or extruded from such flavored thermoplastic polymeric compositions;

such polymeric articles, which exhibit an optimized flavor sensation upon placement in a use environment;

such polymeric articles, which exhibit an optimized flavor sensation upon placement in a use environment and without consuming, dissolving, mastication or destruction of such article;

such polymeric articles, which exhibit enhanced flavorant and flavor enhancing agent migration such that 0-80 percent of the flavorant and flavor enhancing agent are retained at one hour in a use environment, 80-40 percent of the flavorant and flavor enhancing agent are retained at ten hours in a use environment and 40-20 percent of the flavorant and flavor enhancing agent are retained at one hundred hours in a use environment.

### DETAILED DESCRIPTION OF THE INVENTION

It has been discovered that a polymeric article which is not intended to be consumed, significantly destructed, masticated or fully or partially dissolved to release flavor can be rendered to provide an optimized flavor by using “flavor enhancing agents” alone or, preferably, in combination with flavorants. This composition optimizes the flavor of a polymeric article by providing both the aromatic component of flavor (smell), from the use of flavorant, and the taste component of flavor, predominantly through the flavor enhancing agent. This invention also provides a long lasting effect in the article since any surface depletion of the flavorant or flavor enhancing agent is engineered to be replenished from the bulk of the polymer matrix.

The flavor enhancing agents and, optionally, the flavorants may be incorporated into the polymeric carrier by any appropriate method. An article comprising this composition may be achieved through blending flavor enhancing agents, and optionally flavorants, into polymer carriers and then subsequently molding or forming the composition into the finished article. This mixing process may be achieved by melt processing (compounding) the composition, dry-mixing into a polymer powder or mixing into a liquid polymer. The mixing process may occur at any stage of article formation. The composition may be supplied as either a masterbatch (concentrate) or fully formulated compound which may, in turn, be utilized by article manufacturers. It may also be incorporated at the finishing extruder stage of a polymer reactor.

A number of different article manufacturing processes may then utilize the optimized flavor composition, such as extrusion (film or sheet), or molding processes. The final article may be constructed as a monolayer article or may be a coextruded/multilayered article or be an overmolded composition. By such a multi-layer design, the optimized flavor composition may be incorporated into the layer which will be in contact with the oral cavity and may thereby provide further cost reduction.

Selection of the polymeric carrier is based on the desired physical properties of the final application. Common polymeric materials could be any number of thermoplastics, such as but not limited to: polyethylene, polypropylene, any copolymers or terpolymers thereof, elastomers, thermoplastic elastomers, plastomers, ionomers, polybutadiene, polybutylene, polyvinyl chloride, polylactic acid, fluorinated polymers, polystyrenes, polyesters, and polyamides. Other polymeric materials could be used such as silicones (polymerized siloxanes), silicone rubber, rubber, latex, as well as any other thermosets or any combinations thereof. Preferably, polymers which are more amorphous enhance the migration of flavorants or flavor enhancing agents through the matrix thereby improving the sensation of the final flavor. Additionally, the polymer melting or softening point must also be considered since it relates to the temperatures which may be used in processing, or formation of the finished article. The processing temperatures preferably do not surpass the optimized thermal stability of the flavor enhancing agent or flavorants. This aspect is more important when directly incorporating the components into the polymer. Once incorporated into the polymer, through a finishing extruder, concentrate, or compound, the flavorants and flavor enhancing agents are somewhat protected by the polymeric matrix and so during subsequent processes, like molding or extrusion, may be processed at higher temperatures.

Selection of the flavorant most obviously takes into consideration the desired flavor and aroma characteristics. In addition, one must select flavorants which possess adequate thermal stability so that they will withstand the melt processing temperatures of the selected polymer without diminishing the strength or compromising the flavor. These melt processing temperatures can often range between 75 C to 300 C. The flavorant thermal stability is dependent on the compound(s) inherent to or utilized in the production of the flavorant. In addition, some flavorants are contained in water or oil soluble carriers. In this case, oil soluble carrier systems generally provide better thermal stability versus water soluble carrier systems which are based on water, ethanol, glycol, etc. Additionally oil soluble carriers, where present, are better suited or more compatible for the majority of polymers. Based on these criteria, thermally stable flavorants can be designed by the flavorant manufacturer using the appropriate essential oils, natural or artificial substances, or extracts, and, where needed, in an appropriate carrier to allow for incorporation into a melt processable polymer. The flavorant selected must also be one that is safe for human consumption.

Examples of fruit flavorant include flavorant imparting flavor, such as raspberry, strawberry, apple, melon, peach, etc., as well as many other fruit flavorants known in the art. Examples of mint flavorant may be selected from peppermint, cinnamon, or spearmint, as well as other mint flavorants known in the art. Examples of citrus flavorant may be selected from orange, lime or lemon, as well as other citrus flavorants known in the art. Other flavorants such as chocolate, vanilla, etc., may be selected. The flavorant may be selected based on the desired aroma and flavor contribution, thermal stability as described previously, and its compatibility with the polymeric carrier. The flavorant may be added at parts by weight levels from 0.01 to 20%, optionally 1 to 10%, depending on the intensity of the aroma provided by the flavorant, the selected polymer, as relates to its crystallinity and corresponding effect on the regulation of the flavorant migration, as well as the thickness of the final article.

As with flavorants, the selection of flavor enhancing agents also takes into consideration the desired taste as related to the target flavor. Agents which may provide sweetness, sourness, bitterness, saltiness, coolness, unami, fatty acid or acidity may be used and depend on the final flavor target. For example, to optimize fruity or mint flavors, a fruit or mint flavorant in combination with a sweetener may be employed to provide the optimized flavor. Sweeteners can be natural or artificial of bulk or intense type, such as but not limited to, sucrose, fructose, glucose, sorbitol, malitol, xylitol, aspartame, saccharin, sucralose, acesulfame K, mannitol, erythritol, isomalt, lactitol, maltitol, cyclamates, stevia extracts, agave nectar and the like and any combination thereof. Flavor enhancing agents may be added at levels of 0.1 to 50%, optionally at levels between 5 to 20%, by weight.

Flavor enhancing agents also need to be selected based on their thermal stability to tolerate processing temperatures, otherwise a diminished or altered taste could be experienced. The melt processing temperatures can often range between 75 C to 300 C. By way of example, some sweeteners have poor thermal stability and during elevated temperature processing can be carmelized or burnt. Additional co-components or synergists which may protect the flavor enhancing agent during elevated temperature processing can be used to avoid change or alteration of the taste. For example, some sweeteners are combined with maltodextrin, polysaccharides, glycols, glycerides, or esters, or may be encapsulated so as to offer higher thermal stability than the neat sweetener alone. The flavor enhancing agents additionally need to be selected based on their safety for human consumption. Acidic components (acidulants) alone or in combination with flavorant and/or other flavor enhancing agents can optimize the final article flavor. Any acidic component may be considered, such as but not limited to citric acid, ascorbic acid, malic acid, fumaric acid, and any other organic acids or alcohols. Acidic components (acidulants) may be added at levels of 0.01 to 10%, by weight. Cooling agents (those that provide cooling sensation) may also be used alone or in combination with flavorant and/or other flavor enhancing agents to optimize flavor of the final article. Any cooling agent can be considered, such as but not limited to menthol derivatives, menthyl lactate, N,2,3,-trimethyl-2-isopropylbutanamide and the like. Cooling agents may be added at levels of 0.05 to 20% by weight. The flavor enhancing agents additionally need to be selected based on their safety for human consumption.

The optimized flavored composition may also comprise any necessary additives which improve processability, thermal stability, or provide performance or aesthetic attributes to the finished article as long as these additives possess the appropriate safety status. This may include, but is not limited to, additives, such as antioxidants, antistatics, antifogs, antimicrobials, slips, antiblocks, minerals, fillers, optical brighteners, UV stabilizers, foaming agents, nucleating agents, impact modifiers, dispersing aids, release agents, waxes, colorants or pigments.

Flavor enhancing agents, flavorants, as well as additives may be compounded with many different polymers, but exhibiting the desired utility of an organoleptic perception of flavor is critical. Sub-optimal combinations are characterized by short lived organoleptic sensation, i.e., when the flavorant at the surface of the article has been expended, the organoleptic perception of flavor is lost, even though flavorant remains entrapped in the polymer of the article. Consequently, it is essential to optimize the composition to provide the desired migratory capacity of the flavor enhancing agent/flavorant/polymer combinations. Optimal compositions, when placed in a use environment, for example in a stream of flowing water, may be expected to retain approximately 82% of the perceived flavor at 1 hour, 43% at 10 hours and 38% at 100 hours. After two hours of recovery time, the flavor perception may be expected to recover to 88% of the original perceived flavor intensity in a 100 hours water-exposed specimen. It is also essential to optimize the composition to provide the desired taste component through the use of the flavor enhancing agent.

### Experimental Part

The optimized flavored polymeric compositions and their preparation of the present invention will be better understood in connection with the following examples, which are intended as an illustration of and not a limitation upon the scope of the invention.

### Example 1

### Fruit Flavored Polymeric Article

A fruit flavorant, such as raspberry, strawberry, apple, melon, peach, etc. may be used at an appropriate level in a final article to achieve the right intensity of aroma. The flavorant may be selected based on the desired aroma and flavor contribution, thermal stability as described previously, and its compatibility with the polymeric carrier. The flavorant may be added at levels from 0.01 to 20%, optionally 1 to 10%, depending on the intensity of the aroma provided by the flavorant, the selected polymer, as relates to its crystallinity and corresponding effect on the regulation of the flavorant migration, as well as the thickness of the final article. This composition also comprises a flavor enhancing agent, such as a sweetener. The sweetener, such as a sucralose/maltodextrin high intensity sweetener, has improved thermal stability over neat sucralose, may be used at levels of 0.1 to 50%, optionally at levels between 5 to 20%, to provide the appropriate level of taste to the article. Loading level of the sweetener is dependent on the intensity of the sweetener, the polymer, and the thickness of the final article. The use of the flavor enhancing agent alone may be sufficient for some applications where aroma is not required.

A composition of ethylene methylacrylate (EMA), a sucralose/maltodextrin high intensity sweetener, KE-18822 Raspberry flavor, and vitamin E (antioxidant) is dosed into a twin screw extruder. The processing temperatures are set at 100 to 120 C. The resulting pellets are then formed into specimens through an injection molding machine at 160 to 180 C.

### Example 2

### Mint Flavored Polymeric Article

A mint flavorant, such as peppermint or spearmint, may be used at an appropriate level in a final article to achieve the right intensity of aroma. The flavorant may be selected based on the desired aroma and flavor contribution, thermal stability as described previously, and its compatibility with the polymeric carrier. The flavorant may be added at levels from 0.01 to 20%, optionally 1 to 10%, depending on the intensity of the aroma provided by the flavorant, the selected polymer as relates to its crystallinity and corresponding effect on the regulation of the flavorant migration, as well as the thickness of the final article. This composition also comprises a flavor enhancing agent, such as a sweetener. The sweetener, such as a sucralose/maltodextrin high intensity sweetener, may be used at levels of 0.1 to 50%, optionally at levels between 5 to 20%, to provide the appropriate level of taste to the article. Loading level of the sweetener is dependent on the intensity of the sweetener, the polymer, and the thickness of the final article. The use of the flavor enhancing agent alone may be sufficient for some applications where aroma is not required.

A composition of Low Density Polyethylene (LDPE), a sucralose/maltodextrin high intensity sweetener and KE-21570 Mint flavor is dosed into a twin screw extruder. The processing temperatures are set at 100 to 120 C. The resulting pellets are then formed into specimens through an injection molding machine at 160 to 180 C.

### Example 3

### Citrus Flavored Polymeric Article

A citrus flavorant, such as orange or lemon, may be used at an appropriate level in a final article to achieve the right intensity of aroma. This may be at levels from 0.01 to 20% depending on the intensity of the aroma. The flavorant may be selected based on the desired aroma and flavor contribution, thermal stability as described previously, and its compatibility with the polymeric carrier. The flavorant may be added at levels from 0.01 to 20%, optionally 1 to 10%, depending on the intensity of the aroma provided by the flavorant, the selected polymer, as relates to its crystallinity and corresponding effect on the regulation of the flavorant migration, as well as the thickness of the final article. This composition also comprises a flavor enhancing agent, such as a sweetener. The sweetener, such as a sucralose/maltodextrin high intensity sweetener, may be used at levels of 0.1 to 50%, optionally at levels between 5 to 20%, to provide the appropriate level of taste to the article. Loading level of the sweetener is dependent on the intensity of the sweetener, the polymer, and the thickness of the final article. Additionally, another flavor enhancing agent, like an acidulant, such as citric or fumaric acid, may be utilized at levels of 0.01 to 5%, depending on intensity, polymer, and thickness of the final article.

A composition of Low Density Polyethylene (LDPE), a sucralose/maltodextrin high intensity sweetener, Orange flavor, citric acid, and vitamin E (antioxidant) is dosed into a twin screw extruder. The processing temperatures are set at 100 to 120 C. The resulting pellets are then formed into specimens through an injection molding machine at 160 to 180 C.

### Example 4

### Thermogravimetric Analysis of Flavored Polymer

The migrating nature of flavorants in polymers is a characteristic which is critical to the utility of the instant invention. Different flavorant/polymer combinations result in different performance characteristics, an essential characteristic of which is the organoleptic perception of flavor. Many flavorants may be compounded with many different polymers, but to possess the desired utility of an organoleptic perception of flavor is critical. Sub-optimal combinations are characterized by short lived organoleptic sensation, i.e., when the flavorant at the surface of the article has been expended, the organoleptic perception of flavor is lost, even though flavorant remains entrapped in the polymer of the article. Consequently, it is essential to be able to evaluate the migratory capacity of flavorant/polymer combinations.

To this end, polymers with flavor intensities rated as 0, 60, 80, and 100% are analyzed for thermogravimetric (TGA) performance. With these data, a linear relationship between TGA measurement and percent flavor in the polymer may be obtained and plotted with the y axis representing the TGA and the x axis representing the percentage flavor in the polymer.

Under experimental circumstances, the polymer with known flavorant intensity is placed in flowing water for 1, 10, and 100 hours. The results for perceived flavor retention may be plotted. Experimental polymers may be expected to retain approximately 82% of the perceived flavor at 1 hour, 43% at 10 hours and 38% at 100 hours. After two hours of recovery time, the flavor perception may be expected to recover to 88% of the original perceived flavor intensity in a 100 hours water-exposed specimen.

### Example 5

### Flavor Panel Evaluation of Polymers with Flavorants

Flavor panel evaluations are conducted on specimens molded from different flavored compositions. Each composition is first compounded using a twin screw extruder and then injection molded into bars for taste testing. Panelists are assembled to give their opinion on the taste and aroma. Each panelist is required to answer the following questions:
1. Whether the taste represents/resembles the described flavorant, i.e., fruit, mint, etc. (Yes/No)
2. Whether the loading of the flavorant is appropriate to give pleasant taste to the molded article (Rating of 0-5 with 0 means “no taste at all”, 1 is “too weak”, 3 is “just right”, and 5 is “too strong”)
3. Whether the aroma represents/resembles the described flavorant, i.e., fruit, mint, etc. (Yes/No)
4. Whether the loading of the flavorant is appropriate to give pleasant aroma to the molded article (Rating of 0-5)
   Three different base resins: Low Density Polyethylene (LDPE), Linear Low Density Polyethylene (LLDPE), and Polypropylene (PP) are selected for evaluating differences in taste and aroma of the final molded articles and the migration of the flavorants. Two flavorants, raspberry and banana, are chosen for this study.

### Results

The tables below summarize the results from the panel tasting.

TABLE 1
Responses on whether the taste represents the
described fruit, broken down by different resin and
flavorant types.

| | |
|---|---|
| Raspberry | Banana |

| Resin | Yes | No | Yes | No |
|---|---|---|---|---|
| LLDPE | 33% | 67% | 33% | 67% |
| LDPE | 44% | 56% | 39% | 61% |
| PP | 6% | 94% | 0% | 100% |
| Total | 28% | 72% | 24% | 76% |

TABLE 2
Responses on whether the aroma represents the
described fruit, broken down to different resin and
flavorant types.

| | |
|---|---|
| Raspberry | Banana |

| Resin | Yes | No | Yes | No |
|---|---|---|---|---|
| LLDPE | 100% | 0% | 89% | 11% |
| LDPE | 89% | 11% | 94% | 6% |
| PP | 83% | 17% | 83% | 17% |
| Total | 91% | 9% | 89% | 11% |

TABLE 3
Overall rating on loading level, broken down to different
resin and flavorant types.

Average based on

| Category | Type | Taste | Aroma |
|---|---|---|---|
| Base | LLDPE | 0.74 | 2.39 |
| resin | LDPE | 0.76 | 2.60 |
| | PP | 0.44 | 1.49 |
| Flavor | Raspberry | 0.74 | 2.28 |
| | Banana | 0.56 | 2.04 |

The responses summarized in Tables 1 and 2 show that when using flavorant alone, aroma is much more dominant than the taste in overall flavor sensation. 91% and 89% of the respondents can smell raspberry and banana, respectively, compared to only 28% and 24% for taste. In Table 3, we can see that the respondents rate the aroma much closer to 3 (ideal target) than the taste. It is also observed that both aroma and taste perception in polypropylene is consistently lower than both LDPE and LLDPE which suggests that the higher crystallinity polymers inhibit the migration of the flavorant.

### Example 6

### Flavor Panel Evaluation of Polymers with Flavorants and Flavor Enhancing Agents

Flavor panel evaluations are conducted on molded LDPE specimens which comprise a flavorant and a flavor enhancing agent, i.e., a sweetener. Each of the compositions is first compounded using a twin screw extruder and then injection molded into bars for taste testing. Panel testing is conducted after approximately 3 weeks of conditioning the samples at room temperature to make sure the flavors do not volatilize completely within several days after the molding of the specimens. Panelists are assembled to give their opinion on the taste and aroma. Each panel taster is required to answer the following questions:
1. Whether the surface taste represents/resembles the described flavor (Yes/No)
2. Whether the formulation is appropriate to give pleasant taste to the molded article (Rating of 0-5 with 0 means “no taste at all”, 1 is “too weak”, 3 is “just right”, and 5 is “too strong”)
3. Whether the aroma represents/resembles the described flavor (Yes/No)
4. Whether the formulation is appropriate to give pleasant aroma to the molded article (Rating of 0-5)
5. Whether the flavor lasts long enough in mouth. (Yes/No)

### Results

The tables below summarize the results from the panel testing.

TABLE 4
Responses on whether the taste represents the described
flavor.

| Flavor | Yes | No |
|---|---|---|
| Raspberry | 93.3% | 6.7% |
| Mint | 100.0% | 0.0% |

TABLE 5
Responses on whether the aroma represents the described
flavor.

| Flavor | Yes | No |
|---|---|---|
| Raspberry | 80.0% | 20.0% |
| Mint | 93.3% | 6.7% |

TABLE 6
Overall rating on raspberry flavor for three different
formulations.

| Formulation | Taste | Aroma |
|---|---|---|
| 1 | 3.00 | 2.60 |
| 2 | 2.30 | 2.20 |
| 3 | 2.80 | 2.50 |
| Average | 2.70 | 2.43 |

TABLE 7
Overall rating on mint flavor for three different formulations.

| Formulation | Taste | Aroma |
|---|---|---|
| 1 | 3.30 | 3.60 |
| 2 | 2.90 | 3.00 |
| 3 | 3.10 | 3.20 |
| Average | 3.10 | 3.27 |

TABLE 8
Responses on whether the flavor lasts long enough in the
mouth.

| Flavor | Yes | No |
|---|---|---|
| Raspberry | 73.3% | 26.7% |
| Mint | 93.3% | 6.7% |

The results show that both mint and raspberry specimens have good representation of the described flavors and have favorable taste and aroma (with ratings close to the ideal target of 3.0). This panel evaluation demonstrates that the use of a flavor enhancing agent, such as a sweetener, provides the taste sensation which is lacking in the earlier panel evaluations when the specimens comprised flavorant alone.

The present invention is not to be limited in scope by the specific embodiments described herein. Indeed, various modifications of the invention in addition to those described herein will become apparent to those skilled in the art from the foregoing description.

All patents, applications, publications, test methods, literature, and other materials cited herein are hereby incorporated by reference.

We claim:

1. Favored polymeric compositions, comprising one or more heat stable flavor enhancing agent which provides the taste component of flavor, optionally one or more heat stable flavorant, one or more polymer(s) characterized by a capacity for providing for flavor enhancing agent and optional flavorant migration in a finished product, as well as being characterized by thermal stability of the flavor enhancing agent and optional flavorant, wherein the one or more polymer(s) are selected from thermoplastics, thermosets, and silicone polymers, and wherein the composition optionally comprises additives selected from antioxidants, antistatics, antifogs, antimicrobials, slips, antiblocks, minerals, fillers, optical brighteners, foaming agents, nucleating agents, impact modifiers, dispersing aids, release agents, waxes, colorants, pigments, UV stabilizers, wherein articles made from such polymeric compositions are not intended to be consumed, significantly destructed, masticated or fully or partially dissolved to release flavor.

2. The flavored polymeric compositions of claim 1, which are in the form of a masterbatch, a dry-powder or liquid concentrate.

3. The flavored polymeric compositions of claim 1, wherein the polymer is selected from polyolefins, thermoplastic polymers, thermoset polymers, and silicone polymers.

4. The flavored polymeric compositions of claim 1, wherein the polyolefin is selected form polyethylene and polypropylene, copolymers or terpolymers thereof.

5. The flavored polymeric compositions of claim 1, wherein the flavorant is selected from natural and artificial fruit, mint, and chocolate flavors.

6. The flavored polymeric compositions of claim 1, wherein the flavor enhancing agent and flavorant are suitable for human consumption.

7. The flavored polymeric compositions of claim 1, wherein the flavor enhancing agent provides the taste component of flavor.

8. The flavored polymeric compositions of claim 1, wherein the flavor enhancing agent is selected for its ability to provide sweetness, sourness, bitterness, saltiness, coolness, umami, fatty acid, or acidity.

9. The flavored polymeric compositions of claim 8, wherein the sweetness flavor enhancing agent is selected from sucrose, fructose, glucose, sorbitol, malitol, xylitol, aspartame, saccharin, sucralose, acesulfame K, mannitol, erythritol, isomalt, lactitol, maltitol, cyclamates, stevia extracts, agave nectar and the like and any combination thereof.

10. The flavored polymeric compositions of claim 8, wherein the cooling flavor enhancing agent is selected from menthol derivatives, menthyl lactate, N,2,3,-trimethyl-2-isopropylbutanamide and the like.

11. The flavored polymeric compositions of claim 1, wherein the flavor enhancing agent providing for acidity is selected from citric acid, ascorbic acid, malic acid and fumaric acid.

12. The flavored polymeric compositions of claim 1, wherein the compositions are compounded such that flavor and flavor enhancing agent migrate and release or are experienced/perceived without consuming, dissolving, mastication or destruction of an article made from the composition.

13. The flavored polymeric compositions of claim 12, wherein the polymer is selected for its ability to provide flavorant and flavor enhancing agent migration such that 0-80 percent of the optional flavorant and flavor enhancing agent are retained at one hour in a use environment, 80-40 percent of the flavorant and flavor enhancing agent are retained at ten hours in a use environment and 40-20 percent of the flavorant and flavor enhancing agent are retained at one hundred hours in a use environment.

14. The flavored polymeric compositions of claim 1, which are substantially free of a plastic flavor.

15. A polymeric article molded or extruded from a flavored thermoplastic polymeric composition of claim 1.

16. The polymeric article of claim 15, which exhibits an optimized flavor sensation upon placement in a use environment.

17. The polymeric article of claim 15, which exhibits an optimized flavor sensation upon placement in a use environment and without consuming, dissolving, mastication or destruction of such article.

18. The polymeric article of claim 15, which exhibits enhanced flavorant and flavor enhancing agent migration such that 0-80 percent of the flavorant and flavor enhancing agent are retained at one hour in a use environment, 80-40 percent of the flavorant and flavor enhancing agent are retained at ten hours in a use environment and 40-20 percent of the flavorant and flavor enhancing agent are retained at one hundred hours in a use environment.

19. A process for producing a flavored (thermoplastic) polymeric composition, comprising optionally selecting one or more heat stable flavorant, selecting one or more heat stable flavor enhancing agent, selecting one or more polymers for a capacity for providing for flavorant and flavor enhancing agent migration in a finished product, as well as thermal stability of the optional flavorant and flavor enhancing agent, blending the selected optional one or more flavorant(s) and one or more flavor enhancing agent(s) and one or more polymers selected from thermoplastics, thermosets, and silicone polymers, and additives selected from antioxidants, antistatics, antifogs, antimicrobials, slips, antiblocks, minerals, fillers, optical brighteners, foaming agents, nucleating agents, impact modifiers, dispersing aids, release agents, waxes, colorants, pigments, UV stabilizers.

20. A flavored (thermoplastic) polymeric composition which is compounded by the process of claim 19.
